(19) United States
(12) Patent Application Publication
(10) Pub. No.: US 2024/0050782 A1
(43) Pub. Date: Feb. 15, 2024

(54) WEARABLE AIR PURIFIER

(71) Applicant: Dyson Technology Limited, Wiltshire (GB)

(72) Inventor: James Murray ORCHARD, Bath (GB)

(73) Assignee: Dyson Technology Limited, Wiltshire (GB)

(21) Appl. No.: 18/267,407

(22) PCT Filed: Nov. 17, 2021
(86) PCT No.: PCT/GB2021/052978

§ 371 Date: Jun. 14, 2023

(30) Foreign Application Priority Data
Dec. 18, 2020 (GB) 2020098.6

(51) Int. Cl. A62B 18/00; A62B 18/02; A62B 18/08

(52) U.S. Cl. CPC A62B 18/006; A62B 18/025; A62B 18/088

(57) ABSTRACT

A wearable air purification system including a wearable support for on or around a head region of a user; and an air delivery mask connected to the wearable support which is shaped to bound an air delivery region and to deliver a flow of air to the air delivery region. The air delivery mask includes an illumination source located along a longitudinal edge of the air delivery mask, and a control system that is configured to control the illumination source to convey information to a user in response to data received by the control system. The system is configured to direct light to the area occupied by the user's mouth when the air purifier is worn. The form of illumination means that the user's face is more visible to others which reduces facial features being obscured. The control system enables the product to be interactive for the user, delivering status information, and other data to enhance the user experience.

### TECHNICAL FIELD

The disclosure is directed to improvements relating to wearable air purification systems or ‘purifiers’.

### BACKGROUND

We are all becoming more aware of air quality issues, particularly in larger urban areas but also more generally when in public areas where space between individuals may be limited, such as on public transport. Air quality issues may embrace various types of airborne pollutants such as potentially toxic gases and pollen, to name a couple of examples.

The wearing of various forms of face mask to provide some level of protection against at least one form of airborne pollutants and toxins has generally become more accepted. However, usually such masks are passive and are configured simply as a single layer or multilayer assembly of material which is secured to the face of a user by an adjustable strap of some sort. Some people prefer to wear more complicated masks and respirators which offer a more comprehensive filtering functionality, but this usually comes at the expensive of comfort and style. They also are a barrier to clear communication.

Various approaches are apparent in the art that are intended to provide a similar or better level of air purification functionality, but which don't require a user to completely obscure their nose and mouth area by a tight-fitting mask. For example, one approach involves a wearable support such as a neckband or headband to which is attached a bar-like mask or visor which stretches around in front of the mouth and delivers a jet of filtered air. Such approaches show some promise over conventional fabric masks, but they still tend to obscure the user's facial features significantly. They also tend to be bulky which can sometimes be seen as limiting their practicality as an object for daily wear. The current disclosure is direct to addressing at least some of these challenges.

### SUMMARY OF THE INVENTION

According to a first aspect of the invention, there is provided a wearable air purification system comprising a wearable support configured to be supported on or around a head region of a user; an air delivery mask connected to the wearable support which is shaped to bound an air delivery region and to deliver a flow of air to the air delivery region; and an illumination source configured to illuminate at least a portion of the air delivery mask. The system further comprises a control system configured to control the illumination source so as to convey information to a user in response to data received by the control system.

Beneficially, the system or ‘air purifier’ of the invention is configured to direct light to the area occupied by the user's mouth when the air purifier is worn, as well as in some examples providing illumination to a mask or visor of the product itself. In one sense, the examples of the invention provide a more visually appealing product but importantly the form of illumination provided means that the user's face and particularly the mouth region is more visible to others which therefore reduces one of the drawbacks of conventional masks which tend to obscure facial features which makes understanding conversation more challenging. Advantageously, the control system means that the product is interactive for the user, since it can provide various forms of information or data such as alerts, attention getters, and interactive application-driven command responses and feedback directly to the peripheral field of view to the user.

The illumination source may be embodied in various ways so as to achieve benefits for the user. In one example, the illumination source is located at a forward portion of the air delivery mask. This lends itself to the illumination source being in line with the view of the user so that they can perceive the illumination source directly or in their peripheral vision. In some examples, the illumination source may be limited in its extent, e.g. a point of light at a particular location, for example in the centre of the mask, but in other examples the illumination source may extend along a length of the air delivery mask, for example along over 50% of the length of the air delivery mask.

Preferably the illumination source is directional and is oriented to target the air delivery region, which may be achieved by orienting illumination axes so that they are aligned with the delivery region. Therefore in such a configuration the mouth of the user is well illuminated for optimum clarity.

The illumination source may be embodied in various ways. For example, it may comprise a plurality of light emitting elements or devices spread out along the air delivery mask. The light emitting elements may sit on top of the main structure of the mask or may be embedded fully or partially within it, which may help to protect the elements.

In one example the illumination source may comprises a light guide running along the air delivery mask. The light guide may be fed by a light emitting element/device located at or near to the wearable support. Such a configuration may be helpful to reduce power draw of the system.

The system may include an audio system with earpieces to provide a suitable audio source for the user, like a conventional set of headphones, augmented with air purification functionality.

The illumination source may be controlled by a control system which is responsive to appropriate sensing and data inputs. For example, the control system may be configured to control the illumination source to convey information to a user in response to data received by the sensing system. This may achieve visual alerts to the user to indicate various states, such as air quality, filter life, battery health. It may also be beneficial to convey other information to the user, for example as might be available from being interfaced to a computing device of the user, such as a smartphone. The illumination source may therefore be controlled in response to data received from a smartphone in order to alert the user to text messages, other alerts, and general information relating to hosted software applications.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

The above and other aspects of the invention will now be described, by way of example only, with reference to the accompanying drawings, in which:

FIG. 1 is a perspective view of an example of a personal air purifier depicting an example of the invention;

FIG. 2 is a perspective view of an air delivery mask or visor which is part of the air purifier in FIG. 1;

FIG. 3 is an internal view of an earpiece of the air purifier of FIG. 1;

FIG. 4 is a schematic view of a control system of the air purifier;

FIGS. 5 to 7 are side views of other examples of air purifiers according to the invention, and are shown worn on the head of a user; and

FIGS. 8 and 9 are more detailed examples of the air purifier shown in FIG. 7.

Note that features that are the same or similar in different drawings are denoted by like reference signs.

### SPECIFIC DESCRIPTION

Examples of the invention will now be described in detail to provide a thorough understanding of the inventive concept as defined in the claims. However, it will be apparent to the skilled person that the invention may be put into effect without the specific details and that in some instances, well known methods, techniques and structures have not been described in detail in order not to obscure the invention unnecessarily.

In overview the invention provides a wearable air purification product, system or item that is equipped with features to improve its practicality for the user, particularly with regard to how the user's face is perceived by other people, for example during conversations.

The product, which will now be referred to as an air purifier, is provided with a source of illumination which is configured to direct light to the area occupied by the user's mouth when the air purifier is worn, as well as in some examples providing illumination to a mask or visor of the product itself. In one sense, the examples of the invention provide a more visually appealing product but importantly the form of illumination provided means that the user's face and particularly the mouth region is more visible to others which therefore reduces one of the drawbacks of conventional masks which tend to obscure facial features which makes understanding conversation more challenging. The examples of the invention that are illustrated and explained here provide a convenient and elegant solution to these challenges. Further features and advantages will become apparent from the discussion that follows.

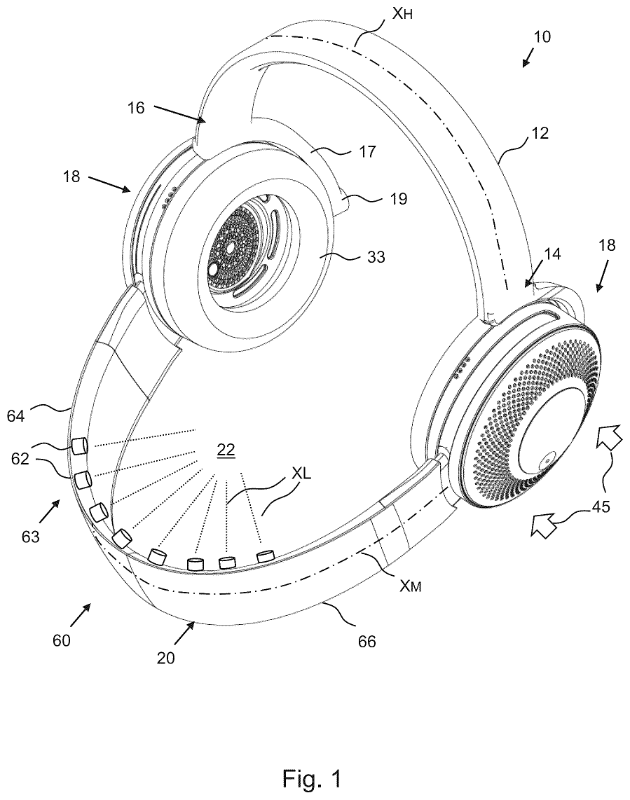

FIG. 1 shows a wearable air purifier 10 to which the examples of the invention relate. The air purifier 10 shown here is very similar to devices disclosed in prior publications belonging to the applicant, such as GB2582372 and WO2020021231. A full discussion of the audio and air purification details will not be provided here for brevity, but a summary is provided below for completeness.

The wearable air purifier 10 is configured to be worn on a user's head, like a conventional set of headphones. For this purpose, therefore, the wearable air purifier 10 comprises a wearable support or ‘headband’ 12 having first and second ends 14, 16 which are connected to respective audio earpieces or ear cups 18. The earpieces 18 are coupled to the wearable support 12 by a conventional movable or rotatable coupling, embodied here by an arcuate arm 17 that extends about a portion of a respective earpiece 18 and engages with that earpiece 18 by a rotational pivot pin 19. Further discussion of this coupling will be omitted for brevity, and the skilled person would appreciate that other couplings would be acceptable.

The earpieces 18 provide the dual functionality of providing audio playback and a purified air flow. The audio play back functionality is provided by a suitable speaker system provided in the earpieces 18 and the air flow is provided by a suitable airflow generator or compressor which is integrated in the earpieces, in this example.

The air purifier 10 also comprises a curved air delivery mask or visor 20 that extends forward of the wearable support 12 and between the earpieces 18 in a pronounced curved configuration to resemble a chin-guard shape, thereby extending about to bound or encircle or define an air delivery region 22. In this example, the air delivery mask 20 is elongated and bar-like in form and is made from a rigid plastics material such as polycarbonate, although this is just optional. The air delivery mask 20 may be transparent, or at least translucent, in form which may be advantageous in certain respects, as discussed further below.

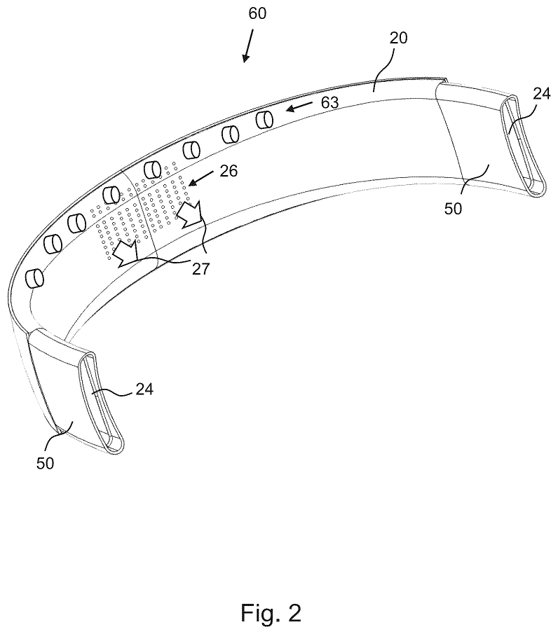

As seen in FIG. 2 more clearly, the air delivery mask 20 is generally a hollow structure and so includes suitable airflow pathways, ducts and channels 24 that convey a flow of air from the compressor along the air delivery mask 20 and direct it towards the user's mouth through at least one nozzle 26. The at least one nozzle 26 may be embodied by a grille or array of holes, as is appropriate. The flow of air is indicated here as ‘27’.

Although in this example the air purifier 10 is designed such that the wearable support 12 fits over the head of a user, it is envisaged that this need not be the case and that in some examples the wearable support may fit around the back of the head or even around the neck area. For the purposes of this discussion, however, the wearable support will be referred to generally as a ‘headband’, although this should be interpreted as extending to similar bands, straps or similar structures that fit around or onto other parts of the head area of the user.

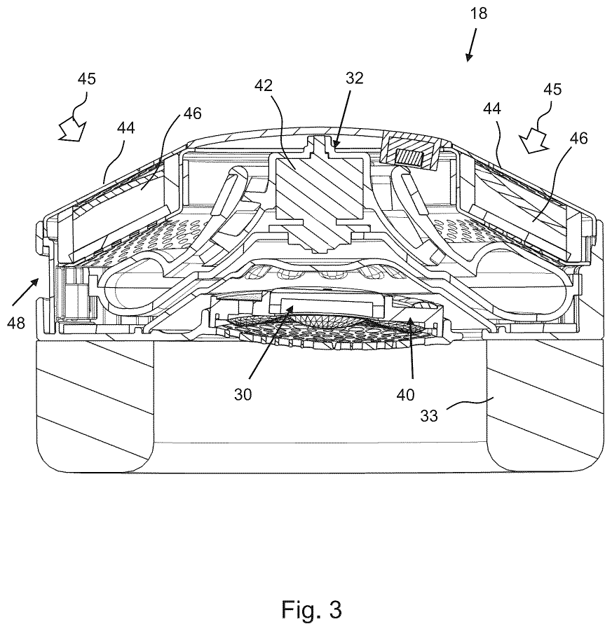

The pair of audio earpieces 18 are generally identical in this example, and a cross section through one of the earpieces 18 is shown in FIG. 3. In order to provide dual audio and air flow functionality the earpiece 18 as shown comprises a speaker assembly 30 at a radial inward position and a compact air purifier unit 32 at a radially outer position. Here, the terms radially “inner” and “outer” are taken with respect to the head of a user on which the air purifier is worn. An ear pad 33 is provided to provide a soft cushioned interface for the user's ear.

The speaker assembly 30 includes a speaker unit 40 comprising speaker and speaker electronics (not shown). A Bluetooth® or other type of wireless communication transmitter/receiver may be provided for wireless communication with an audio playing device. The speaker unit 40 and the air purifier unit 32 may share a battery pack and part of the control electronics (not shown here).

The air purifier unit 32 comprises an airflow generator or compressor 42 for drawing in air through its annular inlet 44 at the outer surface of the earpiece 18. The incoming air 45 is filtered by a filter 46 near the inlet 44 of the air purifier unit 32. The compressor 42 compresses the incoming air 45 that is then expelled from the earpiece 18 through a connector 48 that serves to couple the air delivery mask 20 to the respective earpiece 18. Operation of the compressor 42 therefore draws air into the earpiece 18 and forces it into the air delivery mask 20 and out through the nozzles 26 so as to provide a flow of fresh air to the user.

The connector 48 is shown here as a port that is shaped so as to receive a respective end of the air delivery mask 20 that defines a cooperating plug or connector 50. As can be seen in FIG. 2, those respective ends are also rectangular in form, but having a slightly smaller geometry so that they are receivable by the respective connectors 48 in the earpieces 18. Note that the shape of the connector 48 in FIG. 2 is not shown, but it should be noted that it is shaped to complement and engage with the mask connector 50 and so is generally rectangular in form.

In this example, the connectors 50 of the air delivery mask 20 are male ends that fit into the female ends or sockets provided by the connectors 48 of the earpieces 18. The coupling between the ends of the air delivery mask 20 and the connectors 48 of the earpieces 18 may be flexible to allow for a degree of pivoting or swivelling of the air delivery mask 20 with respect to the earpieces. For example, the end connectors 50 of the air delivery mask may be formed from a short section of flexible hose, e.g. of silicone rubber. Although not shown here, the coupling may also be embodied by a rotational joint to allow the air delivery mask 20 to pivot rotationally downwards out of the way of the user's mouth.

When considering the air purifier 10 shown in FIG. 1, it will be appreciated that the device is shown in the wearable configuration as it would be when worn on the head of a user. In this configuration, the headband 12 and the air delivery mask 20 extend in approximately orthogonal directions away from the earpieces 18. That is, the curved shape of the headband 12 can be considered to define a first plane X_{H} and the curved shape of the air delivery mask 20 can be considered to define a second plane X_{M} which, as can be appreciated from FIG. 1 are transverse to one another and, more specifically, are approximately orthogonal to one another.

Referring to each earpiece 18, therefore, the connection with the headband 12 is approximately at the 3 o'clock position, by virtue of the pivot pin 19, whilst the main section of the headband 12 extends away from the earpiece 18 at the 12 o'clock position, and the connection with the air delivery mask 20 is approximately at the 9 o'clock position. One challenge associated with wearable air purifiers is that they tend to cover the user's mouth and so are an obstacle to clear communication. Although the air delivery mask 20 in the illustrated embodiment may be transparent or translucent to aid communication, it may still act as a barrier. The illustrated wearable air purifier incorporates features that are intended to address these challenges. As such, the air purifier includes an illumination source 60 that is configured to illuminate the air delivery region 22.

As can be seen in FIG. 1 particularly, the illumination source 60 is defined by the air delivery mask 20 and is directed or focussed towards the air delivery region 22 which means that it will illuminate the mouth of a user when the device is in operation and being worn on a user's head.

One embodiment of the illumination source 60 is shown in FIGS. 1 and 2. Here, the illumination source 60 comprises a plurality of light emitting elements 62, only some of which are labelled for clarity. The light emitting elements 62 are arranged in a linear array 63, in the illustrated example, so as to present a band of light directed towards the air delivery region 22. Here, the light emitting elements 62 extend along a longitudinal or upper edge 64 of the air delivery mask 20. Each light emitting element 62 has an illumination axis, shown here as X_{L}. As can be seen in FIG. 1 particularly, the illumination axes X_{L} of the light emitting elements 62 converge generally to the air delivery region 22 so as to enhance the illumination effect. The light emitting elements 62 are therefore directional and are targeted on the air delivery region 22. It will be appreciated from FIG. 1 that the illumination axes X_{L} are aligned generally with each other in a common plane, which coincides with the plane X_{M} defined by the curvature of the air delivery mask 20.

The light emitting elements 62 may in principle may be any suitable device that is able to emit light. For example, incandescent lamps are one option, but more technically suitable would be miniature light emitting diodes (LEDs) because of their small size, and range of available colours. Moreover, in the illustrated embodiments, the light emitting elements 62 are shown as separate devices, but it should be noted that this is for illustration purposes only and the light emitting elements could instead be integrated onto a substrate strip for easy application to the air delivery mask 20.

For a particularly elegant solution, the light emitting elements 62 may be integrated within the confines of the air delivery mask 20. For example, if the air delivery mask 20 is embodied as a solid component e.g. of transparent polycarbonate, it could be provided with a suitable mounting aperture or apertures such as slots, channels, holes or ports into which the light emitting elements 62 may be received, either singly, or in a strip form. In this sense, therefore, the light emitting elements may be embedded either partly or entirely within the air delivery mask. Such a configuration could be useful in providing a flat smooth surface for the mask which may provide improved aesthetics but also presents fewer traps for dirt and bacteria.

As shown in FIG. 2, the light emitting elements 62 are distributed along a significant length of the mask 20, and more specifically about 50% of the length of the mask 20, but centred around the middle. Considered another way, the light emitting elements 62 extend around approximately 60 to 90 degrees of arc of the air delivery mask 20. It is envisaged that in some examples the light emitting elements 62, in whatever configuration they may be, may extend along 120 or even 180 degrees of arc, such that they run along substantially the entire top or upper edge 64 of the air delivery mask 20.

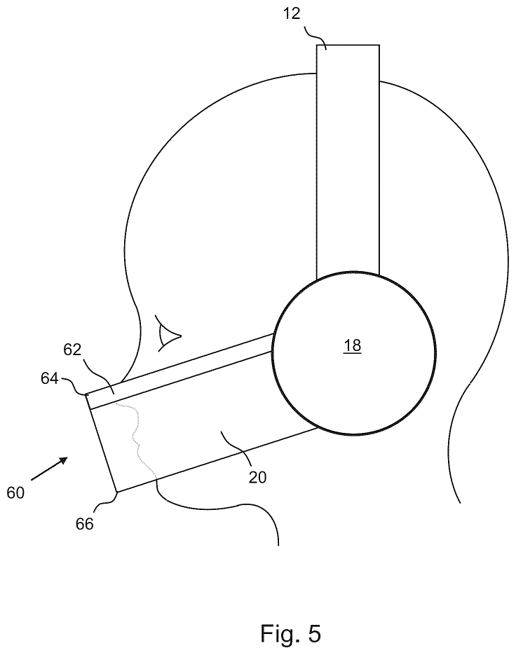

FIGS. 5 to 7 illustrate further examples of how an illumination source 60 could be configured in the context of the air delivery mask 20 of the air purifier 10 of the invention. Note that the same reference numerals will be used to refer to features which are the same or similar in nature to features described with respect to and shown in the previous figures.

Referring firstly to FIG. 5, this shows a side view of a human head wearing the air purifier as illustrated in FIGS. 1 and 2. In a similar way, the illumination source 60 in FIG. 5 is common to that shown in FIGS. 1 and 2 because it is located along the upper edge 64 of the air delivery mask 20. Although FIGS. 1 and 2 depict the illumination source 60 as individual light emitting elements 62, the illumination source 60 in FIG. 5 is depicted as a continuous strip, as has been discussed above.

In addition to the illumination source 60 being configured to illuminate the air delivery region 22 directly, it should be appreciated that the illumination source 60 is located in a location in which it can be perceived well by the user's peripheral vision. As the air delivery mask 20 extends forward of and around the user's mouth, it will be noted that the position of the illumination source 60 along the top edge 64 of the mask 20 means that it is located in the lower edge of the user's field of view when they are looking forward. Positioned in this way, the illumination source 60 provides a means to deliver visual information to the user. For example, it is envisaged that the illumination source 60 could be configured to provide a variety of visual indicia to represent various useful information that may aid the user when using the air purifier. Further discussion on this aspect will be covered later.

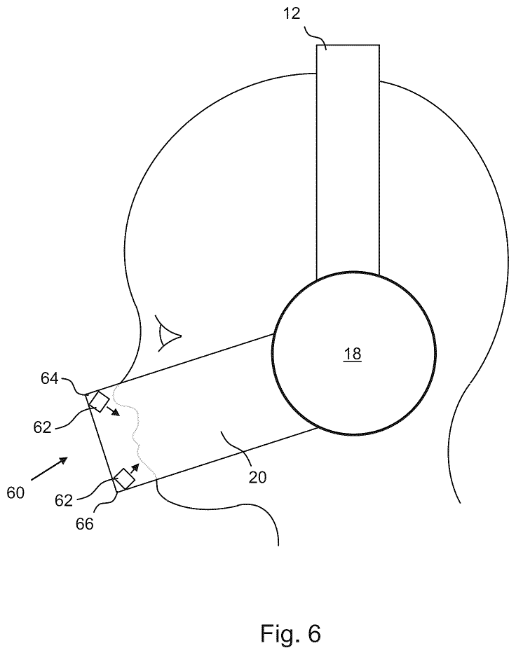

FIG. 6 provides a view similar to that in FIG. 5. Here the transparent nature of the air delivery mask 20 can be appreciated, and it will also be noted that the illumination source 60 includes one or more light emitting elements 62 located along the top edge 64 of the air delivery mask 20 and also along the bottom edge 66. As FIG. 6 is schematic in nature, it should be appreciated that only one light emitting element 62 is shown on each of the top edge 64 and the bottom edge 66 of the air delivery mask 20, but actually there may be a plurality of light emitting elements 62 extending around a significant angle of arc of the curved air delivery mask 20.

In this example, it is envisaged that configuring the air delivery mask 20 to comprise two sets of light emitting elements 62 in which one set extends along the top edge 64 of the mask and the other set extends along the bottom edge 66 of the mask, means that the air delivery region 22 is the focus of light rays from two converging angles as shown in FIG. 6, which may provide a more complete illumination of the mouth region of the user.

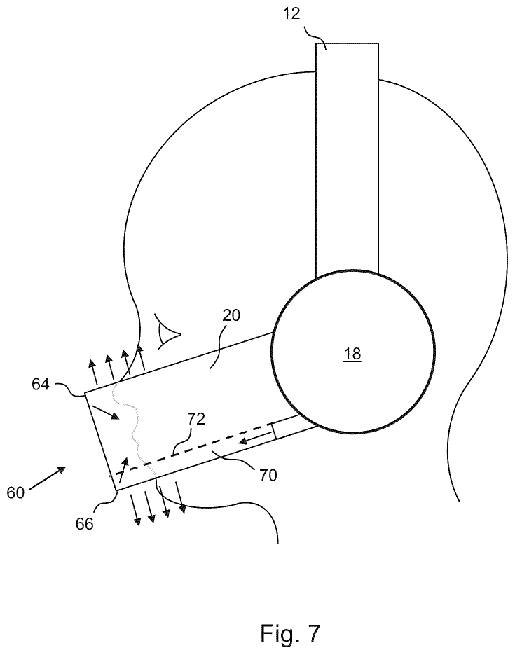

Turning now to FIG. 7, in this example the air purifier 10 includes an illumination source 60 that is arranged along the bottom edge 66 of the air delivery mask 60. However, whereas in the previous embodiments the illumination source 60 was defined by a plurality of light emitting elements 62 distributed around the air delivery mask 20, in this example the illumination source 60 is defined by a light guide 70.

In the example of FIG. 7 the light guide 70 is defined by the air delivery mask 20 and extends along at least a portion of the length of the mask. As the illumination source 60 is a light guide 70, it may be an integral part of the air delivery mask 20, that is, the guide is an integral part of the material of the air delivery mask 20. The air delivery mask 20 may itself be the entirety of the light guide, as one option, or as another option, the light guide may be defined in a smaller part of the mask. For example, as shown in FIG. 7, the light guide 70 is defined by a suitable light channel 72 in the mask. The light channel 72 may be defined by walls or surfaces that are optically opaque so as to serve the function of guiding the light within the light channel 72.

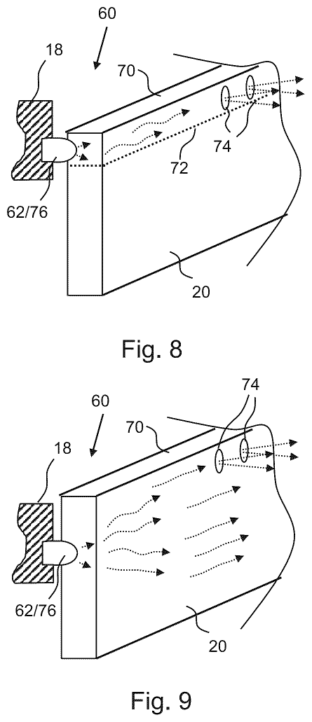

This configuration is shown from a different perspective in FIG. 8. Note that the light channel 72 is integral with the material of the air delivery mask 20. This may be achieved by forming the light channel 72 and the rest of the air delivery mask 20 as separate components and then joining them together in some way, for example using an appropriate bonding compound or ultrasonic welding. Another option is that the air delivery mask 20 may be formed by way of an additive manufacturing process in which the wall of the light channel 72 separating the channel from the remainder of the mask material may be formed in an appropriate way.

In FIG. 8, it can be seen that the light guide 70 includes a plurality of windows or apertures 74 that permit the light within the light guide 70 to escape and be directed towards the air delivery region 22. The apertures 74 can therefore be considered to provide the same function as the light emitting elements as discussed with the previous examples.

Only two apertures 74 are shown, although it should be appreciated that there may be more. It should also be noted that although discrete apertures 74 are shown here, the apertures could instead be formed as an elongate aperture or slot.

Light is injected into the light guide 70 by a suitably mounted LED 76 or other suitable light source that is housed within a component of the air purifier 10 other than the air delivery mask 20. As shown here the LED 76 is mounted in, on or near an earpiece 18 of the air purifier. Conveniently, the LED 76 may be surface mounted directly on a circuit board that is located in the earpiece 18.

FIG. 9 shows a still further variant in which the entirety of the air delivery mask 20 acts as the light guide. In this example, the material of the air delivery mask 20 would be an optical-grade plastics which would carry the light along the mask from one end to the other which would give the impression that the entire air delivery mask 20 glows with light. Suitable one or more apertures 74 are provided to direct light from the light guide 70 to the air delivery region 22.

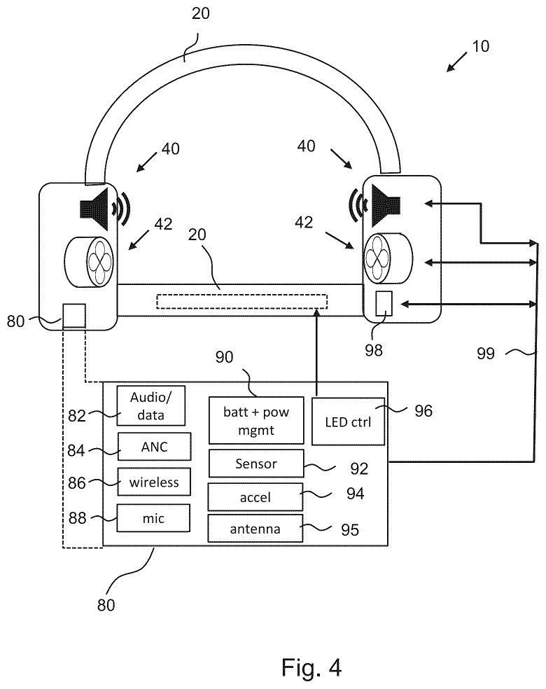

As discussed above, in all configurations of the air purifier 10 shown here, the illumination source 60 may be operable to provide status information to the user. To this end the illumination source 60 is part of a control system of the air purifier 10 and therefore is operably connected to a controller, an example of which is shown schematically in FIG. 4.

The controller 80 is used here as a general term to refer to the computing hardware, software and firmware required to control the electronic functionality of the air purifier 10. In overview, the controller 80 may include suitable modules to control various aspects of the air purifier 10, and may comprise an audio control module 82, an active noise cancelling module 84, a wireless module 86, a microphone module 88, a battery and power management module 90, a sensor and data interface module 92, an antenna module 94, a fan control module 95 and a illumination source control module 96.

Also depicted in FIG. 4, in schematic form, are the speaker units 40 and the airflow generator 42 of each earpiece 18 which are operably connected to the controller 80, as well as an appropriate multi-function sensor module 98 which is configured to monitor one or more of the air flow rate from the earpieces 18, air quality and battery power level. All of those units are coupled to the controller 80 by way of a suitable communication bus 99. Although not show here, it should be noted that the communications bus 99 would be configured to link both earpieces 18. Finally, the controller 80 is operably connected to the illumination source 60, as discussed above, so that the illumination source control module 96 can apply suitable control commands thereto.

It should be appreciated at this point that several of the control modules mentioned above are conventional in the art of audio headphones and air purification. Therefore, further discussion of these will not be provided since it is not central to the invention. Note also that the many functional sub-modules included in the controller 80, as described above, is for convenience of illustration. Those sub-modules may be provided as a system-on-chip (SOC) design, or may be provided as separate modules on a larger circuit board.

The illumination source control module 96 may be configured to provide the illumination source with certain functionality. In its most simple form, the illumination source control module 96 may simply have the functionality to turn the illumination source on or off in response to a predetermined trigger. The trigger may be the main power on/off switch for the air purifier or some other suitable control input, such as via a remove software application e.g. hosted on a smartphone device.

The illumination source control module 96 may be operable in response to input from one or more of the multi-function sensor module 98, the data interface module 92 and or any other one of the modules in the controller 80 so as to achieve certain functionality that is useful to the user. Some examples of this now follow.

In one example, the illumination source control module 96 is configured to receive data regarding air quality from the sensor module 98. Here, the illumination source control module 96 is responsive to that data to change the lighting configuration of the illumination source 60. For example, the illumination source 60 may be caused to flash, flicker, or change colour in response to the air quality being found to be above or below and predetermined air quality threshold. In one specific example, the illumination source 60 could be caused to turn to a predetermined colour that is usually associated with an alert, such as yellow, orange or red. In this case, the illumination source 60 would be embodied by a suitable LED having multi-colour functionality, or indeed more than one LED each having the required colour.

In another example, the illumination source control module 96 may be configured to receive data from the battery and power management module 90. In response to receiving this data, the illumination source control module 96 may be configured to display certain indica to the user to indicate battery status. This may be done in various ways. For example, upon power one, the illumination source control module 96 may be configured to cause the illumination source 60 to pulse green for a predetermined time period to indicate a ‘good’ battery status. Similarly, a yellow pulse could be used for a ‘medium’ battery level status and a red pulse could be used for a ‘poor’ battery level status indicating that charging is recommended.

In a further example, the illumination source control module 96 may be configured to receive data indicating the filter life of the system. This could be derived for example from the current consumed by the airflow generator because a blocked filter generally increases motor loading which increases current consumption. Another option is the filter life to be linked to a simple timer that increments whilst the device is running. Filter life may therefore be set based on the run time of the unit, but may also take into account other factors such as air quality and so on in order to improve accuracy. As in previous examples, the illumination source control module 96 may be configured to flash or pulse a predetermined light pattern or sequence and/or a predetermined light colour to the user as a means of an attention getter.

The illumination source may be controlled in various ways in order to achieve useful functionality. For example, the illumination source may be configured to be coordinated with outside data inputs, as would be available from interfacing with a computing device such as a smartphone or similar. For example, the illumination source could be controlled so as to indicate to the user that a call, message, or other alert has been received. This could be achieved by colour change, a change in lighting intensity, pulsing, flickering or other light modulation. Furthermore, it is envisaged that the illumination source could be controlled via a computing device to provide feedback to the user about certain applications that may be in use. For example, in the case of a software application that may be used for meditation purposes, the illumination source could be controlled to modulate its output in such a way so as to coordinate with the breathing rate of the user. This could enhance the meditational experience. It is also envisaged that the illumination source could be configured to display directional information to the user, for example under the control of a navigation software application hosted on a smartphone, which may be GPS enabled. The illumination source could therefore illuminate around a part of the mask in order to indicate direction.

Several different examples embodying the invention have been described above and some variants have also been explained. However, the skilled person would understand that other variants and modifications to those specific examples would be possible without departing from the inventive concept as defined by the claims.

1: A wearable air purification system comprising:
a wearable support configured to be supported on or around a head region of a user;
an air delivery mask connected to the wearable support which is shaped to bound an air delivery region and to deliver a flow of air to the air delivery region;
an illumination source configured to illuminate at least a portion of the air delivery mask; and
a control system configured to control the illumination source so as to convey information to a user in response to data received by the control system.

2: The system of claim 1, wherein the control system is operable to sense air quality, and, in response, to control the illumination source to provide an alert to the user that is indicative of the sensed air quality.

3: The system of claim 1, wherein the control system is operable to detect remaining filter life and, in response, to control the illumination source to provide an alert to the user indicative of the remaining filter life of the system.

4: The system of claim 1, wherein the control system is operable to detect battery life and, in response, to control the illumination source to provide an alert indicative of the remaining battery life of the system.

5: The system of claim 1, wherein the illumination source is embedded in the air delivery mask.

6: The system of claim 1, wherein the illumination source is located at a forward portion of the air delivery mask.

7: The system of claim 6, wherein the illumination source is centered around the middle of the length of the air delivery mask.

8: The system of claim 1, wherein the illumination source extends along or near to an edge of the air delivery mask.

9: The system of claim 1, wherein the illumination source is directional and is oriented to target the air delivery region.

10: The system of claim 9, wherein the illumination source defines one or more light direction axes (X_{L}) which are aligned with the air delivery region.

11: The system of claim 1, wherein the illumination source comprises a light guide to carry light within it and direct light to the air delivery region.

12: The system of claim 11, wherein the illumination source comprises one or more light emitting devices located in or near to the wearable support, and that are optically coupled to the light guide.

13: The system of claim 1, further comprising an audio system comprising at least one earpiece supported by the wearable support.

14: The system of claim 13, wherein the audio system comprising a pair of earpieces wherein the wearable support extends between and supports each of the pair of earpieces.

15: The system of claim 14, wherein the air delivery mask extends between the pair of earpieces.
